(19) United States
(12) Patent Application Publication
(10) Pub. No.: US 2026/0034527 A1
(43) Pub. Date: Feb. 5, 2026

(54) DUST GENERATION APPARATUS

(71) Applicant: Diesel Emissions Analysis Systems Pty Ltd, Port Kembla (AU)

(72) Inventors: Paul Bartley, Primbee (AU); Michael Kon, Wollongong (AU); Vinodkumar Gopaldasani, Fairy Meadow (AU); Brian Davies, Figtree (AU)

(73) Assignee: Diesel Emissions Analysis Systems Pty Ltd, Port Kembla (AU)

(21) Appl. No.: 19/285,400

(22) Filed: Jul. 30, 2025

(30) Foreign Application Priority Data
Jul. 31, 2024 (AU) 2024205233

(51) Int. Cl. B01F 29/64; B01F 23/30; B01F 29/00; B01F 33/25; B01F 33/82; B01F 101/23

(52) U.S. Cl. CPC B01F 29/64; B01F 23/30; B01F 29/40; B01F 33/251; B01F 33/82; B01F 2101/23

(57) ABSTRACT

A dust generation apparatus is disclosed. The dust generation apparatus includes: a drum defining a drum chamber for receiving a sample; an agitation system in the drum chamber for agitating the sample to generate an aerosol of the sample in the drum chamber, the agitation system including: at least one first agitator rotatably mounted about a rotational axis extending through the drum chamber to stir the sample in the drum chamber; and a plurality of second agitators configured to tumble in the drum chamber during rotation of the at least one first agitator.

### CROSS-REFERENCE TO RELATED APPLICATION

A claim for priority to the Jul. 31, 2024 filing date of Australian Patent Application No. 2024205233, titled DUST GENERATION APPARATUS (“the '233 application”) is hereby made pursuant to 35 U.S.C. § 119(b). The entire disclosure of the '233 application is hereby incorporated herein.

### TECHNICAL FIELD

The present disclosure relates to an apparatus for generating dust from a sample for analysis. Embodiments of the apparatus may be used for the calibration of dust monitoring instruments for direct reading of dust levels in real-time.

### BACKGROUND

Occupational exposure to Respirable Crystalline Silica (RCS) is a known cause of respiratory and non-respiratory diseases in many countries. Silicosis is an often fatal occupational disease caused by inhalation of RCS. Silica exposures are documented for workers involved in quarrying, mining, construction, and related industries.

End-of-shift monitoring as well as in-field measurement of RCS is undertaken to manage exposure. However, these approaches do not provide a real-time, immediately actionable reading of occupational exposure to RCS. Typically, workplace exposure samples are collected on site and transported to an accredited laboratory for analysis, which can take many weeks.

In the laboratory, dust generators are designed to produce airborne dust for analysis using different dust generating mechanisms. For example, some dust generators produce dust aerosols using aerodynamic lift and self-abrasion.

The inventors of the apparatus disclosed herein recognise that it would be desirable to reduce or ameliorate one or more shortcomings of present dust generators, or at least provide a useful alternative thereto.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

Throughout this specification the words “comprise”, “include”, and variations such as “comprises”, “comprising”, “includes” and “including”, will be understood to imply the inclusion of a stated element, integer or step, or group of elements, integers or steps, but not the exclusion of any other element, integer or step, or group of elements, integers or steps.

### SUMMARY

Some embodiments relate to a dust generation apparatus comprising: a drum defining a drum chamber for receiving a sample; an agitation system in the drum chamber for agitating the sample to generate an aerosol of the sample in the drum chamber, the agitation system comprising: at least one first agitator rotatably mounted about a rotational axis extending through the drum chamber to stir the sample in the drum chamber; and a plurality of second agitators configured to tumble in the drum chamber during rotation of the at least one first agitator.

The dust generation apparatus may further comprise a plenum defining a plenum chamber configured to receive the dust aerosol from the drum chamber. The dust generation apparatus may further comprise a sample extraction vent having an inlet in the plenum chamber for collecting a sample of the dust aerosol, and an outlet configured to be connected to a dust measurement device. The inlet of the sample extraction vent may comprise a plurality of inlet apertures extending across the plenum chamber in a direction perpendicular that in which to an outlet from the drum chamber discharges the dust aerosol into the plenum chamber. The plurality of inlet apertures of the extraction vent may face the outlet from the drum chamber.

The drum chamber may be in fluid flow communication with the plenum chamber via a conduit comprising a conduit inlet and a conduit outlet, the conduit inlet extending into the drum chamber and the conduit outlet extending into the plenum chamber. The conduit inlet may comprises a plurality of inlet apertures that are longitudinally spaced apart. The conduit may be fixedly connected relative to the at least one first agitator, such that the conduit and the at least one first agitator rotate together about the rotational axis.

The dust generation apparatus may further comprise a vacuum system configured to generate a pressure differential between the drum chamber and the plenum chamber to cause the dust aerosol to flow from the drum chamber into the plenum chamber through the conduit. The dust generation apparatus may comprise at least one air inlet port for inletting air into the drum chamber.

The dust generation apparatus may comprise a motor configured to rotate the at least one first agitator about the rotational axis. The at least one first agitator may be fixedly connected to the drum, such that the drum and the at least one first agitator rotate together about the rotational axis. The second agitators may be configured to tumble in the drum chamber in response to the rotation of the at least one first agitator. The second agitators may be balls. The second agitators may be of a material that is harder than that of the sample. The second agitators may have a textured external surface. The second agitators may be of steel. The sample may be bound or unbound.

The at least one first agitator may be configured to scoop the second agitators and release them at an elevated location in the drum chamber. The at least one first agitator may comprise a plurality thereof evenly circumferentially spaced about an inner surface of the drum. Each said at least one first agitator may comprise a blade extending from an inner surface of the drum into the drum chamber.

The volume of the drum chamber in cubic metres may be between approximately 0.5 and approximately 1.0 times the mass of the sample in kilograms, and may, for example, be approximately 0.7 times the mass of the sample in kilograms. The volume of the plenum chamber in cubic metres may be between approximately 1.0 and approximately 2.0 times the mass of the sample in kilograms, and may, for example, be approximately 1.3 times the mass of the sample in kilograms.

The relationship between the number N of second agitators and the volume V of the drum chamber in cubic metres may be approximately 10000V<N<40000V or 10000V<N<20000V or 10000V<N<15000V, or 10000V≈N.

### BRIEF DESCRIPTION OF DRAWINGS

FIG. 1 shows a dust generation apparatus, according to some embodiments of the present disclosure;

FIG. 2A is a first section view of a drum chamber of the dust generation apparatus of FIG. 1, according to some embodiments;

FIG. 2B is a second section view of the drum chamber of FIG. 2A;

FIG. 3A is a first section view of a plenum chamber of the dust generation apparatus of FIG. 1, according to some embodiments; and

FIG. 3B is a second section view of the plenum chamber of FIG. 3A.

### DETAILED DESCRIPTION

The present disclosure relates to an apparatus for generating dust from a sample for analysis. Embodiments of the present disclosure may be used for the calibration of dust monitoring instruments for direct reading of dust levels in real-time.

Embodiments of the present disclosure may provide an apparatus for real-time measurement and analysis of dust levels to enable timely interventions in work areas where exposure to high levels of Respirable Crystalline Silica (RCS) is detected. A real-time measurement and analysis apparatus may also enable testing and analysis of host ore materials before mining and quarrying operations are carried out.

Embodiments of the present disclosure may provide a portable apparatus for creating reproducible airborne dust clouds in the laboratory or in the field. A portable apparatus capable of creating reproducible airborne dust clouds may assist in the development of standardised in-field calibration methods to produce real-time RCS analysis using portable instrumentation. The portable apparatus may be referred to as a portable dust generator or dust generation device.

Often, it is preferable for a dust generation device to produce dust which is similar in particle size, shape and composition to a natural form of the dust, and which is essentially free from contamination resulting from grinding.

Dust generators can be classified based on their method of dust generation, as follows:
Class A dust generators generate dust by fluidization (ventilation of gas dispersion), where the dust is directly entrained into airflow in a tube resulting in re (suspension).
Class B dust generators produce dust by gravitation (drop or “impact” method), where a source sample falls through the air into or within an enclosed chamber from which the generated dust is evacuated.
Class C dust generators generate dust by mechanical dispersion or agitation (rotating drum and similar techniques), where the source material repeatedly falls from top to bottom of a horizontal, rotating cylinder or tube and the dust is entrained into the air.

Class C generators produce aggregate collisions similar to the ones resulting from saltation/sand blasting processes. The inventors have identified Class C generators as appropriate for the production of mineral dust with characteristics similar to those of the dust observed in natural conditions.

The present disclosure relates to a Class C apparatus for generating dust from samples containing crystalline silica. The dust generator, according to some embodiments of the present disclosure, may provide researchers, occupational hygienists, and other professionals with lighter, less bulky equipment that can be deployed in the field for dust generation activities. The dust generator may provide an easy to use system for generating real-time dust monitoring data.

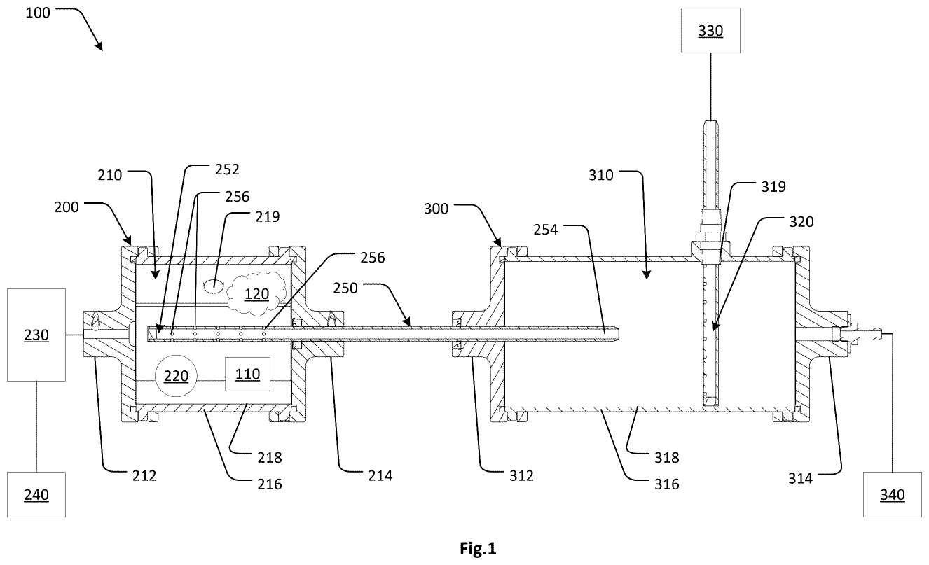

FIG. 1 shows a dust generation apparatus 100, according to some embodiments of the present disclosure. The dust generation apparatus 100 may receive a sample 110 containing particulates for sampling. For example, the sample 110 may be mulch or soil, and the particulates for sampling may include silica or asbestos. The dust generation apparatus 100 may generate a dust aerosol 120 from the sample 110, wherein the dust aerosol 120 contains particulates of the sample 110. The dust generation apparatus 100 may be used to maintain the dust aerosol 120.

The dust generation apparatus 100 may comprise a drum 200 defining a drum chamber 210 for receiving the sample 110. The drum chamber 210 may contain an agitation system 220 for agitating the sample 110 to generate an aerosol in the drum chamber, such as dust aerosol 120. The dust generation apparatus 100 may comprise a motor 230 configured to cause relative movement between the agitation system 220 and the sample 110 to generate the dust aerosol 120 in the drum chamber 210. The motor 230 may be configured to rotate the drum 200 to cause the relative movement between the agitation system 220 and the sample 110. The motor 230 may be operated and controlled by a controller 240. For example, the controller 240 may control a speed, mode, or operating time of the motor 230. The controller 240 may be configured to operate the motor 230 to rotate the drum 200 in a smooth manner, such as with gradual changes in rotation speed. The inventors have identified that a sharp jolt to the drum 200, such as by a sudden increase in rotation speed, produces a spike in the dust cloud which adversely affects the dynamics of the dust aerosol 120. The inventors have identified that it is preferable to maintain consistency of the dust aerosol 120.

The drum 200 may comprise a first end 212 and a second end 214 connected by a wall 216. An inner surface 218 of the wall 216 may at least in part define the drum chamber 210. The wall 216 may define a sample inlet 219 for inserting the sample 110 into the drum chamber 210. Passage through the sample inlet 219 may be controlled by a hatch, screw cap, plug or other device for limiting ingress to the drum chamber 210. In the illustrated embodiment, the sample inlet 219 is approximately 10 mm to 12 mm in diameter.

The dust generation apparatus 100 may further comprise a conduit 250 comprising a conduit inlet 252 and a conduit outlet 254. The conduit 250 may be configured to extract at least part of the dust aerosol 120 from the drum chamber 210 for analysis. The conduit 250 may be a tube comprising a tube wall defining a lumen through which the dust aerosol 120 can flow. In some embodiments, the conduit inlet 252 extends into the drum chamber 210. The conduit inlet 252 may be a portion of the conduit 250 that extends into the second end 214 of the drum 200, while the conduit outlet 254 may be a portion of the conduit 250 that extends out of the second end 214 of the drum 200. The dust generation apparatus 100 may further comprise at least one air inlet port for inletting air into the drum chamber 210. The first end 212 of the drum 200 may define a plurality of the air inlet ports. The air inlet ports may be disposed upwind of the conduit inlet 252. The sample inlet 219 may be disposed between the air inlet ports and the conduit inlet 252.

The conduit inlet 252 may define or comprise at least one inlet aperture 256. The at least one inlet aperture 256 may be formed in the tube wall of the conduit 250. The conduit inlet 252 may define or comprise a plurality of the inlet aperture 256. The plurality of the inlet aperture 256 may be longitudinally spaced apart. In some embodiments, the plurality of inlet apertures 256 is defined by the conduit inlet 252 at several circumferential positions in the tube wall of the conduit inlet 252. The plurality of inlet apertures 256 may be defined by the conduit inlet 252 at evenly spaced circumferential positions in the tube wall of the conduit inlet 252.

The motor 230 may be connected to the drum 200 along an axis of rotation of the drum 200 that is coaxial with the conduit 250. The motor 230 may cause the drum 200 to rotate about the conduit 250, wherein the conduit 250 remains stationary (non-rotating). In some embodiments, the conduit 250 is configured to rotate with the drum 200.

Continuing to refer to FIG. 1, the dust generation apparatus 100 may further comprise a plenum 300 defining a plenum chamber 310 configured to receive the dust aerosol 120 from the drum chamber 210. The drum chamber 210 may be in fluid flow communication with the plenum chamber 310 via the conduit 250. The conduit outlet 254 may extend into the plenum chamber 310 to direct the dust aerosol 120 into the drum chamber 210. The conduit outlet 254 may direct the dust aerosol 120 towards a sample extraction vent 320 configured to be connected to a dust measurement device 330, wherein the sample extraction vent 320 extends into the plenum chamber to collect a portion of the dust aerosol 120. The sample extraction vent 320 may have an inlet configured to be disposed in the plenum chamber 310 to collect a sample of the dust aerosol 120. The sample extraction vent 320 may have an outlet configured to be connected to the dust measurement device 330. It may be desirable to collect only the respirable dust particles (nominally having a size less than 10 microns) via the sample extraction vent 320. Drawing the dust aerosol 120 into the plenum 300 before extraction of a sample via the sample extraction vent 320 facilitates larger and heavier particles of dust in the dust aerosol 120 falling out of the dust aerosol 120 in the plenum 300, which in turn facilitates lighter, respirable dust particles from the dust aerosol 120 being extracted via the sample extraction vent 320. For example, the plenum 300 may be sized and configured so that the conduit outlet 254 and the sample extraction vent 320 are disposed at or towards opposite ends of the plenum chamber 310. This may facilitate the larger and heavier particles of dust in the dust aerosol 120 settling towards the bottom of the plenum chamber 310, leaving the lighter and smaller, respirable dust particles suspended in the dust aerosol 120 for extraction by the sample extraction vent 320. The sample 110 may contain particulates of less than 500 micrometres in size and the sample 110 may have a minimum weight of approximately 1.0 g. The sample 110 may be bound or unbound.

The plenum 300 may comprise a first end 312 and a second end 314 connected by a wall 316. An inner surface 318 of the wall 316 may at least in part define the plenum chamber 310. The wall 316 may define an aperture 319 for inserting the sample extraction vent 320 into the plenum chamber 310. The aperture 319 may be sealed to prevent leakage of the dust aerosol 120 from the plenum chamber 310 during sampling by the sample extraction vent 320.

The dust generation apparatus 100 may further comprise a vacuum system 340. The vacuum system 340 may be configured to generate a pressure differential to cause the dust aerosol 120 to exit the drum chamber 210. The vacuum system 340 may be configured to generate a pressure differential to cause the dust aerosol 120 to exit the drum chamber 210 through the conduit 250. The vacuum system 340 may be configured to generate a pressure differential between the drum chamber 210 and the plenum chamber 310 to cause the dust aerosol 120 to flow from the drum chamber 210 into the plenum chamber 310 through the conduit 250.

Continuing to refer to FIG. 1, the dust generation apparatus 100 may further comprise a filter (not shown) between the plenum 300 and the vacuum system 340. The filter may comprise a filter cassette. The filter cassette may be a 37 mm filter cassette. The filter may be fitted in line between the plenum 300 and the vacuum system 340 to protect the vacuum system 340 from the ingress of excess dust.

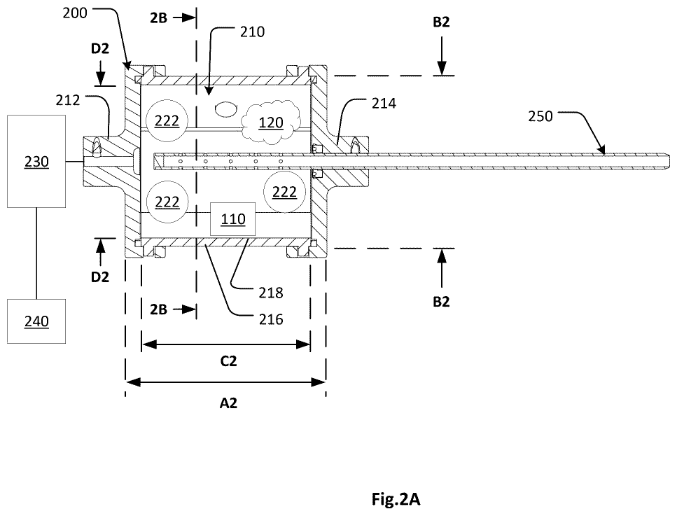

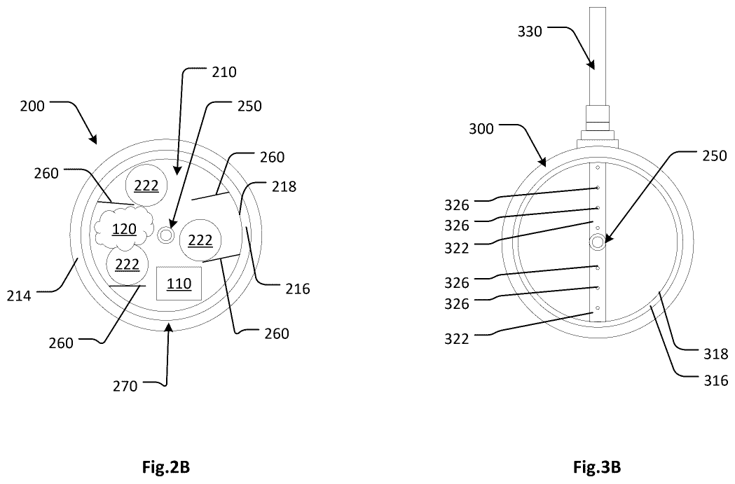

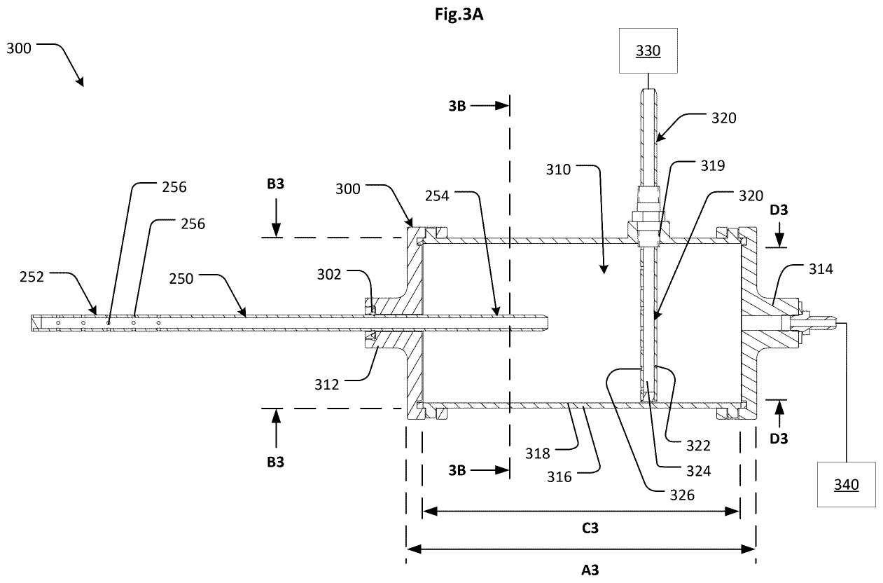

The dust generation apparatus 100 may be connected to a frame and/or enclosed in a housing (not shown) to facilitate transport and portability. Exemplary dimensions for a dust generation apparatus 100 for a sample 110 of approximately 1.0 g in mass will now be provided. Referring to FIG. 2A, the drum 200 has a length A2 of approximately 120 mm and a diameter B2 of around 100 mm, while the drum chamber 210 has a length C2 of approximately 100 mm and a diameter D2 of around 95 mm. The drum wall 216 is approximately 3 mm thick. Referring to FIG. 3A, the plenum 300 has a length A3 of approximately 205 mm and a diameter B3 of around 100 mm, while the plenum chamber 310 has a length C3 of approximately 190 mm and a diameter D2 of around 95 mm. The plenum wall 316 is approximately 3 mm thick. The volume of the drum chamber 210 in cubic metres is between approximately 0.5 and approximately 1.0 times the mass of the sample 110 in kilograms and, in the illustrated embodiment is approximately 0.7 times the mass of the sample 110 in kilograms. The volume of the plenum chamber 310 in cubic metres is between approximately 1.0 and approximately 2.0 times the mass of the sample 110 in kilograms and, in the illustrated embodiment is approximately 1.3 times the mass of the sample 110 in kilograms.

The drum 200 and plenum 300 may be formed from any material that is suitable for the envisaged conditions, including characteristics of the sample 110. For example, if the sample 110 is abrasive, corrosive or has a surface charge, then the drum 200 and plenum 300 may be of a material that is abrasion resistant, corrosion resistant or anti-static or static dissipative.

In some embodiments, the vacuum system 340 is connected to the plenum chamber 310 so that the conduit outlet 254 is located in the plenum chamber 310 upstream of the sample extraction vent 320. For example, the vacuum system 340 may be connected to the second end 314 of the plenum chamber 310, the conduit outlet 254 may be connected to the first end 312 of the plenum chamber 310, while the sample extraction vent 320 is located in between the conduit outlet 254 and the vacuum system 340. The conduit outlet 254 may be arranged to direct the dust aerosol 120 into the sample extraction vent 320. The inlet of the sample extraction vent 320 may be disposed within a stream of airflow between the conduit outlet 254 and the vacuum system 340, such as shown in FIG. 3B.

In some embodiments, the vacuum system 340 is connected to a distal end of the plenum 300 while the conduit outlet 254 is connected with a proximal end of the plenum 300, and the inlet of the sample extraction vent 320 is coplanar with the conduit outlet 254 and the vacuum system 340, such as shown in FIG. 3B.

In some embodiments, the agitation system 220 comprises at least one first agitator rotatably mounted about a rotational axis. The at least one first agitator may extend through the drum chamber to stir the sample in the drum chamber. The agitation system 220 may further comprise a plurality of second agitators configured to tumble in the drum chamber 210 during rotation of the at least one first agitator. In some embodiments, the conduit 250 is fixedly connected relative to the at least one first agitator of the agitation system 220, such that the conduit 250 and the at least one first agitator rotate together about the rotational axis. Turning to FIGS. 2A and 2B, the agitation system 220 comprises a plurality of second agitators 222 configured to tumble or otherwise move around inside the drum chamber 210. The plurality of second agitators 222 may tumble inside the drum chamber 210, in response to the rotation of the at least one first agitator and/or the drum 200. The tumbling motion of the second agitators may facilitate the generation of the dust aerosol 120.

The at least one first agitator may be fixedly connected to the drum 200 such that the drum 200 and the at least one first agitator may rotate together about the rotational axis. The at least one first agitator may comprise a plurality of the first agitator, wherein each first agitator may be evenly circumferentially spaced about the inner surface 218 of the drum 200. The motor 230 may be configured to rotate the at least one first agitator about the rotational axis at approximately 12 RPM. Each of the at least one first agitator may comprise a blade 260 extending from the inner surface 218 of the drum 200 into the drum chamber 210. The at least one first agitator or blade 260 may extend from the inner surface 218 at an angle to a radius of the drum chamber 210. The at least one blade 260 may extend from the inner surface 218 along a radius of the drum chamber 210. The at least one blade 260 may be paddle shaped. The at least one blade 260 may extend along the inner surface 218 between the first and second ends 212, 214 of the drum 200. The at least one blade 260 may be connected to the first and second ends 212, 214 of the drum 200 and extend therebetween along the inner surface 218. The at least one blade 260 may have a substantially flat profile. The at least one blade 260 may have a profile comprising surface variations to provide different angles and surfaces for engaging the plurality of second agitators 222. For example, the at least one blade 260 may have a profile comprising a combination of flat portions and scalloped or dimpled portions. The rotation of the at least one first agitator 260 may accordingly cause the plurality of the second agitators 222 to tumble in the drum chamber 210 in response.

The second agitators 222 may be regularly shaped, such as spherical. The second agitators 222 may be irregularly shaped. The second agitators 222 may comprise a mixture of regularly shaped agitators and irregularly shaped agitators.

At least some of the second agitators 222 may be in the shape of a spherical ball. There may be a plurality of balls 222; for example, 8, 12, or 24 balls. The number and/or size of the balls may be chosen based on properties of the sample 110, such as its total mass and/or the size of particulates it contains, and/or of the drum 200, such as the volume or geometry of the drum chamber 210. The number and/or size of the balls may be chosen based on the length of the drum chamber 210, as measured between the first and second ends 212, 214. For a drum 200 of set diameter, a longer drum chamber 210 defines a larger surface area at the bottom of the drum chamber 210 compared to a shorter drum chamber 210. The larger surface area provides more space for the sample 110 to settle at the bottom portion 270 of the drum chamber 210. More of the second agitators 222 or balls 222 may therefore be required to provide coverage of the bottom portion 270 to reduce the likelihood of portions of the sample 110 being untouched. The relationship between the number N of second agitators 222 and the volume V of the drum chamber 210 in cubic metres may be approximately 10000V<N<40000V. That is, for a drum chamber 210 having a volume V of 7.1×10⁻⁴ m³, the number N of second agitators 222 may be between about 7 and 28. In some embodiments, the inner surface 218 of the drum chamber 210 comprises an inclined portion which is configured to guide the sample 110 and the second agitators 222 or balls 222 towards a common area in the drum chamber 210 to increase the likelihood of impact and assist dust generation. The steel balls may have a diameter of approximately 8 mm. For example, a higher number of smaller sized balls may create a higher number of small magnitude interactions with the sample 110 when the drum 200 is rotated, while a lower number of larger sized balls may create a lower number of large magnitude interactions with the sample 110 when the drum 200 is rotated. This can be used to affect the concentration, duration and consistency of the dust aerosol 120.

In some embodiments, the second agitators 222 are balls that have a textured external surface. The textured external surface may be configured to abrade the sample 110. In some embodiments, the second agitators 222 are of a material that is harder than that of the sample 110. The second agitators 222 may be made of steel. The balls may be steel balls, such as ball bearings. Steel provides high wear resistance to the second agitators or balls 222 to withstand the repeated tumbling motions. High wear resistance of the second agitators 222 reduces the risk of contaminating the sample 110 with the material of the second agitators 222. In some embodiments, the second agitators 222 grind or abrade the sample 110 to facilitate generating the dust aerosol 120 and maintain the dust aerosol 120 for longer periods of time. The inventors have found that it is typically preferable that the second agitators 222 do not crush the sample 110.

Embodiments of the dust generation device 100 are capable of producing dust aerosols 120 from a sample 110. In at least some embodiments, the dust aerosols 120 produced are similar in particle size, shape and composition to natural dust and/or are free from contamination resulting from grinding of the sample 110.

In some embodiments, the drum 200 comprises a plurality of the at least one blade 260. The drum 200 may comprise 2, 3, 4, or more of the blades 260. In the embodiment shown in FIG. 2B, the drum 200 comprises four of the blades 260. Each of the blades 260 may be evenly circumferentially spaced along the inner surface 218 of the drum 200. Each of the blades 260 may extend from the inner surface 218 at a different angle to each other.

Each of the at least one blade 260 may be configured to scoop and release at least one of the plurality of second agitators 222 with the rotation of the drum 200. The blade 260 may be configured to scoop and release at least one of the plurality of second agitators 222 at an elevated location in the drum chamber 210. For example, when the drum 200 is in a first rotated position, at least one of the plurality of second agitators 222 and/or the sample 110 may be at a bottom portion 270 of the drum chamber 210. During rotation of the drum 200 to a second rotated position, the plurality of second agitators 222 and/or the sample 110 may roll along the bottom portion 270 of the drum chamber 210 under gravity, until coming into contact with one of the blades 260. Further rotation of the drum 200, such as to a third rotated position, may cause the plurality of second agitators 222 and/or the sample 110 to be picked up by the blade 260, moving away from the bottom portion 270 of the drum chamber 210. Subsequent rotation of the drum 200 may cause the plurality of second agitators 222 and/or the sample 110 to eventually fall off the blade 260, impacting the bottom portion 270 of the drum chamber 210. As the drum 200 continues to rotate, the plurality of second agitators 222 and/or the sample 110 are picked up from and dropped to the bottom portion 270 of the drum chamber 210, creating a tumbling motion that agitates the sample 110 and breaks it into dust to facilitate or maintain the dust aerosol 120. The second agitators 222 may thereby deagglomerate the sample 110 into individual particles by mechanical impact and/or microscale turbulent shearing stresses.

The plurality of inlet apertures 256 may be configured to face the plurality of blades 260. Aligning the plurality of inlet apertures 256 with the plurality of blades 260 may facilitate the suction of the dust aerosol 120 into the conduit inlet 252. The conduit outlet 254 may be formed in an opposite end of the conduit 250 to the plurality of inlet apertures 256.

Turning to FIGS. 3A and 3B, the plenum 300 comprises a seal 302 configured to receive the tube wall of the conduit 250. The seal 302 may be configured to allow rotation of the conduit 250 while the plenum 300 remains stationary.

The sample extraction vent 320 may be a pipe comprising a pipe wall 322 defining a lumen 324 through which the dust aerosol 120 can flow from the plenum chamber 310 to the dust measurement device 330. The pipe wall 322 may define a plurality of perforations 326 configured to collect a portion of the dust aerosol 120 in the plenum chamber 310.

The plurality of perforations 326 may be formed on only one side of the pipe wall 322. The pipe wall 322 may be oriented in the plenum chamber 310 so that the plurality of perforations 326 faces the conduit outlet 254. Operation of the vacuum system 340 may then cause particulates of the dust aerosol 120 to flow from the conduit outlet 254 towards the inlet of the sample extraction vent 320. The particulates of the dust aerosol 120 may then enter the perforations 326 without escaping through another perforation in the pipe wall 322. The dust measurement device 330 may employ suction to draw the particulates of the dust aerosol 120 along the pipe, away from the perforations 326 and towards the dust measurement device 330.

In some embodiments, the inlet of the sample extraction vent 320 comprises a plurality of inlet apertures. The plurality of inlet apertures may extend across the plenum chamber 310 in a direction perpendicular that in which to an outlet from the drum chamber 210 discharges the dust aerosol 120 into the plenum chamber 310. The plurality of inlet apertures of the extraction vent may face the outlet from the drum chamber 210.

The inventors of the apparatus disclosed herein have performed testing and validation of the dust generation apparatus 100. The validation process and results are available in the following research paper:
David Dennis Tettey Noi, Brian Davies, Linda Apthorpe et al., “Validation of a Novel Dust Generator using Respirable Crystalline Silica”, 8 Apr. 2024, PREPRINT (Version 1) available at Research Square [https://doi.org/10.21203/rs.3.rs-4146184/v1]
   the entire content of which is incorporated herein by reference. Selected extracts of the research paper are also reproduced below.

The dust generation apparatus 100 is a relatively simple dust generation system that is portable and can reproduce dust clouds distinct for each type of material tested. The concentration of the dust cloud can be adjusted to that required buy simple adjustments. No such simple device to produce dust clouds in the field is known to exist. Complex laboratory systems are common but not portable and very expensive. There are laboratory dust generators commercially available but they are large, expensive and not portable. They usually operate on either an air injection system or brush process to generate the dust cloud.

Direct reading instrumentation for the measurement of dust levels in workplaces suffer from calibration issues due to interferences in the host material, which may result in incorrect analysis. The dust generation apparatus 100 provides a means by which a dust cloud of the host material can be generated and a correction factor calculated to correct for interferences before any analysis using the direct instrumentation is undertaken in the workplace.

The preparation of calibration standards for respirable crystalline silica analysis by Fourier Transform Infrared (FTIR) and XRD has suffered from the inability to generate calibration standards quickly and accurately. The dust generation apparatus 100 simplifies this process and allows the quick and accurate generation of such calibration standards. There would be a market for the dust generation apparatus 100 especially for remote sites where laboratory facilities are not available and also for the calibration of direct reading real-time dust monitoring instruments.

A third possible use of the dust generation apparatus 100 is in the evaluation of risk of asbestos fibres being in the air at parks etc. arising from contaminated mulch or soil. By taking a sample of the contaminated mulch or soil and using the dust generation apparatus 100 a dust cloud which may contain asbestos fibres could be generated and subsequently analysed. If there are no (or limited) fibres present in the generated dust cloud the Public Health risk would be minimal.

A known mass of <500 um host material is placed in a rotating drum along with 12 steel balls. The rotating drum is then collected via a tube with small holes in it at one end and connected to a stationary plenum. The motor to the rotating drum is switched on and a small Thomas pump draws air and entrained dust particles into the plenum. A secondary tube with holes in it is inserted into the plenum at 90 degrees and either connected to a dust monitoring instrument or drawn though a pre-weighed filter.

The rotating drum has four paddle blades spaced equidistant along the sides of the drum to pick up and drop the host material and steel balls as the drum rotates. The steel balls act similar to a SAG mill and grinds the material while the pickup and dropping of the dust by the paddles generates the dust cloud.

The dust generation apparatus 100 is a portable dust generator that has been developed for in-field use to enable the quantification of RCS in various dust clouds, and can produce dust clouds for up to two hours and subsequently prepare calibration curves using a quartz reference standard for FTIR. The portable dust generator can generate dust clouds of host materials in varying to determine when control strategies are required to be employed. It also provides a means to generate samples of host material for identification of analytical interferences of portable instruments.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A dust generation apparatus comprising:
a drum defining a drum chamber for receiving a sample;
an agitation system in the drum chamber for agitating the sample to generate an aerosol of the sample in the drum chamber, the agitation system comprising:
at least one first agitator rotatably mounted about a rotational axis extending through the drum chamber to stir the sample in the drum chamber; and
a plurality of second agitators configured to tumble in the drum chamber during rotation of the at least one first agitator.

2. The dust generation apparatus of claim 1, further comprising a plenum defining a plenum chamber configured to receive the dust aerosol from the drum chamber.

3. The dust generation apparatus of claim 2, further comprising a sample extraction vent having an inlet in the plenum chamber for collecting a sample of the dust aerosol, and an outlet configured to be connected to a dust measurement device.

4. The dust generation apparatus of claim 3, wherein the inlet of the sample extraction vent comprises a plurality of inlet apertures extending across the plenum chamber in a direction perpendicular that in which to an outlet from the drum chamber discharges the dust aerosol into the plenum chamber.

5. The dust generation apparatus of claim 4, wherein the plurality of inlet apertures of the extraction vent face the outlet from the drum chamber.

6. The dust generation apparatus of claim 2, wherein the drum chamber is in fluid flow communication with the plenum chamber via a conduit comprising a conduit inlet and a conduit outlet, the conduit inlet extending into the drum chamber and the conduit outlet extending into the plenum chamber.

7. The dust generation apparatus of claim 6, wherein the conduit inlet comprises a plurality of inlet apertures that are longitudinally spaced apart.

8. The dust generation apparatus of claim 6, wherein the conduit is fixedly connected relative to the at least one first agitator, such that the conduit and the at least one first agitator rotate together about the rotational axis.

9. The dust generation apparatus of claim 6, further comprising a vacuum system configured to generate a pressure differential between the drum chamber and the plenum chamber to cause the dust aerosol to flow from the drum chamber into the plenum chamber through the conduit.

10. The dust generation apparatus of claim 1, wherein the at least one first agitator is fixedly connected to the drum, such that the drum and the at least one first agitator rotate together about the rotational axis.

11. The dust generation apparatus of claim 1, wherein the second agitators are configured to tumble in the drum chamber in response to the rotation of the at least one first agitator.

12. The dust generation apparatus of claim 1, wherein the at least one first agitator is configured to scoop the second agitators and release them at an elevated location in the drum chamber.

13. The dust generation apparatus of claim 1, wherein the at least one first agitator comprises a plurality thereof evenly circumferentially spaced about an inner surface of the drum.

14. The dust generation apparatus of claim 1, comprising at least one air inlet port for inletting air into the drum chamber.

15. The dust generation apparatus of claim 1, wherein the second agitators are balls.

16. The dust generation apparatus of claim 1, wherein the second agitators are of a material that is harder than that of the sample.

17. The dust generation apparatus of claim 1, wherein the second agitators have a textured external surface.

18. The dust generation apparatus of claim 1, wherein the second agitators are of steel.

19. The dust generation apparatus of claim 1, wherein the number (N) of second agitators and the volume (V) of the drum chamber in cubic metres satisfies: 10000V<N<40000V or 10000V<N<20000V or 10000V<N<15000V, or 10000V≈N.

20. The dust generation apparatus of claim 1, wherein the volume of the drum chamber in cubic metres is between approximately 0.5 and approximately 1.0 times the mass of the sample in kilograms.
